(19) United States
(12) Patent Application Publication
(10) Pub. No.: US 2012/0216572 A1
(43) Pub. Date: Aug. 30, 2012

(54) METHOD AND APPARATUS FOR REMOVING PHOSPHORUS AND BORON FROM POLYSILICON BY CONTINUOUSLY SMELTING

(75) Inventors: Yi Tan, Dailian (CN); Wei Dong, Dalian (CN); Guobin Li, Dalian (CN); Dachuan Jiang, Dalian (CN)

(73) Assignee: Dalian University of Technology, Dalian Liaoning (CN)

(21) Appl. No.: 13/510,357

(22) PCT Filed: Nov. 17, 2010
(86) PCT No.: PCT/CN2010/078817

§ 371 Date: May 17, 2012

(30) Foreign Application Priority Data
Nov. 19, 2009 (CN) 200910220059.0

(51) Int. Cl. C01B 33/037

(52) U.S. Cl. 65/83; 65/356

(57) ABSTRACT

The present invention relates to the polysilicon purification technology field with physical metallurgy technology, especially to a method for removing P and B impurities in the polysilicon using electron beam melting technology. In this method, two electron guns are used for irradiating electron beam to melt polysilicon, meanwhile, P and B are removed in a dual process. P will firstly be removed, and then B will be further removed through further melting for evaporation. At last the low-B and low-P polysilicon evaporated on the deposit board is collected. In the equipment used, the vacuum cover and vacuum circular cylinder constitutes the shell of the device; the inner part of vacuum circular cylinder is the vacuum chamber, which is formed by the left and right part and divided by the separation plate. This method effectively improves the purity of the polysilicon and achieves the requirements for solar grade silicon with perfect purification effect, stable technology, and high efficiency.

### TECHNOLOGY FIELD

The present invention relates to the polysilicon purification technology field with physical metallurgy technology, especially to a method for removing P and B impurities in the polysilicon using electron beam melting technology.

### BACKGROUND TECHNOLOGY

It is recognized that high purity polysilicon is required as the prime raw material for solar cells. Conventional preparation of high purity polysilicon is mainly Siemens, specifically including the silane decomposition method and gas phase hydrogen reduction of chlorosilane. Siemens is the mainstream silicon purification technology whose effective deposit ratio is 1×10³, 100 times that of silane. Siemens deposition rate is up to 8˜10 μm/min min and its conversion efficiency is 5% to 20% with a deposition temperature of 1100° C. merely inferior to SiCl₄ 1200° C., moreover, the power consumption is about 120 kWh/kg, which is relatively higher. Through years of effort, domestic power consumption of SiHCl₃ method has been reduced from 500 kWh/kg to 200 kWh/kg, and silicon rods obtained with the diameter of about 100 mm. Deficiencies of Siemens lie in its backward thermal chemical vapor deposition in core areas, too many process links and a low conversion efficiency, which results in a lasting process and an increase in material consumption as well as energy costs. Compared to this, metallurgy mainly referred to directional solidification method based on the differences in segregation coefficients of impurities in the silicon is low energy consumption and minor environmental pollution among so many new preparation technologies. The single method of directional solidification cannot remove the P impurities with larger segregation coefficient, and among the impurities in silicon, B is the harmful impurity, which directly affects the resistivity of silicon material and the lifetime of minority carriers, thereby affecting the photoelectric conversion efficiency for solar cells. The content of P in polysilicon used for preparation of solar cells should be controlled to lower than 0.00003%. Japanese patent for invention with No. 11-20195 has achieved the purpose of removal of P in silicon using electron beam while fail to remove B. The reports about P and B have been removed simultaneously have not been found in patents and scientific papers so far using electron beam in a single equipment.

### Invention Contents

The present invention solves the technical problem by removing impunity of P in the polysilicon to the level of 0.00001% and impurity of B to the level of 0.00003% using electron beam melting technology, and reaching the requirements for silicon material of solar cells.

The present invention employs a method for removal P and B from polysilicon by continuous melting, using two electron gun for transmitting electron beam to melt polysilicon, and P and B are removed simultaneously in a dual process. P was firstly removed, and then B in polysilicon with low content of P will be further removed through further melting for evaporation. The low-B and low-P polysilicon evaporated to the deposit board is collected.

These steps as follows:
1) Take the polysilicon material 22 into the water-cooled copper crucible 17. The polysilicon material 22 is hold in about the one third position of the water-cooled copper crucible 17. Close the vacuum cover 18;
2) Vacuum process, start up the left rotary pump 19, the left roots pump 20, the right rotary pump 4, and the right roots pump 3 to get the vacuum chamber to low vacuum of 1 Pa, and then start up the left diffusion pump 21 and the right diffusion pump 2 to get the vacuum chamber to high vacuum of below 0.001 Pa;
3) Pass the cooling water into water-cooled copper crucible 17 through the left water-cooled supporting bar 14 and pass the cooling water into water-cooled copper tray 12 through the right water-cooled supporting bar 13, maintaining the temperature of the water-cooled copper crucible and cooled copper tray below 50° C.;
4) Preheat the left electron gun 24 with the high-voltage of 25-35 kV for 5-10 minutes. Then turn off the high-voltage and set the beam current of left electron gun 24 for 70-200 mA. After preheat for 5-10 minutes, turn off the beam current of left electron gun 24;
5) Preheat the right electron gun 5 with the high-voltage of 25-35 kV for 5-10 minutes. Then turn off the high-voltage and set the beam current of right electron gun 5 for 70-200 mA. After preheat for 5-10 minutes, turn off the beam current of right electron gun 5;
6) Turn on the high-voltage and the beam current of the left electron gun 24 simultaneously. After stability of the beam current, bombard the polysilicon material 22 in the water-cooled copper crucible 17 with the left electron gun 24. And then increase the beam current of the left electron gun 24 to 500-1000 mA and sustain bombardment, until the polysilicon 22 melts into low-P polysilicon 10;
7) Put polysilicon 22 into the water-cooled copper crucible 17 constantly through the filler port 23, so that the low-P polysilicon 10 overflows into the graphite crucible 11;
8) Turn on the high-voltage and the beam current of the right electron gun 5 simultaneously. After stability of the beam current, bombard the low-P polysilicon material 10 in the middle of the graphite crucible 11 with the right electron gun 5. And then increase the beam current of right electron gun 5 to 500-1000 mA and sustain bombardment;
9) Rotate the supporting bar 1 of the deposition plate 6, take the speed of rotation of the deposition plate 6 to 2-30 rotations per minute, and collect the low-B silicon 7 evaporated to plate;
10) Put polysilicon material 22 into the water-cooled copper crucible 17 constantly through the filler port 23, so as to ensure the sustainability of the reaction process;
11) After the collecting process, turn off the left electron gun 24 and the right electron gun 5, and continue to pump the vacuum for 10-20 minutes;
12) Turn off the left diffusion pump 21 and the right diffusion pump 2 in turn and continue to pump the vacuum for 5-10 minutes, then turn on the left roots pump 20 and the right roots pump 3, the left rotary pump 19 and the right rotary pump 4, open the valve 15 and vacuum cover 18 and take out silicon from the deposition plate 6;

In the equipment, the vacuum cover 18 and vacuum circular cylinder 8 constitutes the shell of the equipment; the inner part of vacuum circular cylinder 8 is the vacuum chamber 9, which is formed by the left and right part and divided by the separation plate 16; the two parts are connected by a square port 25; Left water-cooled supporting bar 14 is fixed to the left bottom of the vacuum circular cylinder 8; Water-cooled copper crucible 17 is mounted on the left water-cooled supporting bar 14, and the right side of water-cooled copper crucible 17 is connected to the graphite crucible 11 in the right inner part through the square port 25; The left electron gun 24 is fixed on the left side of the vacuum circular cylinder 8, just over the water-cooled copper crucible 17; The right water-cooled supporting bar 13 is fixed on the right bottom of the vacuum circular cylinder 8, and the water-cooled copper tray 12 is installed on the right water-cooled supporting bar 13; The graphite crucible 11 is placed on the water-cooled copper tray 12, and the right electron gun 5 is fixed on the right side of the vacuum circular cylinder 8; The deposition plate 6 is connected to the supporting bar 1 and they are installed on the right inner top of the vacuum circular cylinder 8, just over the graphite crucible 11; The filler port 23, the left rotary pump 19, the left roots pump 20, the left diffusion pump 21 and the valve 15 are installed on the left side of the vacuum circular cylinder 8 respectively; The right rotary pump 4, the right roots pump 3 and the right diffusion pump 2 are installed in the upper right of the vacuum circular cylinder 8 respectively.

In the equipment, the deposition board 6 is made of silicon, ceramic or other material which has a low wetting with silicon.

Significant effects of this invention are to removal B with larger segregation coefficient and simultaneously remove P through the use of electron beam melting method. It solves the bottleneck of B removal by current metallurgical methods and the problem of simultaneously removing P and B, effectively improving the purity of the polysilicon and achieving the requirements for solar grade silicon with perfect purification effect, stable technology and high efficiency.

### DESCRIPTION OF FIGURES

FIG. 1 is equipment for B removal in the polysilicon by regional evaporation,

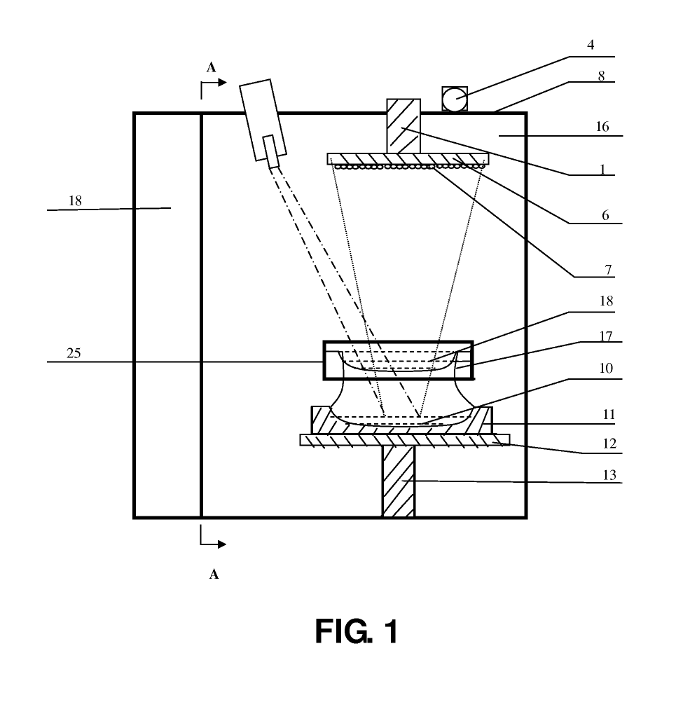

FIG. 2 is a view of the A-direction of the FIG. 1. As shown in these figures, 1. Supporting bar, 2. Right diffusion pump, 3. Right roots pump, 4. Right rotary pump, 5. Right electron gun, 6. Deposition board, 7. Low-B polysilicon, 8. Vacuum circular cylinder, 9. Vacuum chamber, 10. Low-P polysilicon, 11. Graphite crucible, 12. Water-cooled copper tray, 13. Right water-cooled supporting bar, 14. Left water -cooled supporting bar, 15. Valve, 16. Separation plate, 17. Water-cooled copper crucible, 18. Vacuum cover, 19. Left rotary pump, 20. Left roots pump, 21. Left diffusion pump, 22. Polysilicon material, 23. Filler port, 24. Left electron gun, 25. Square port.

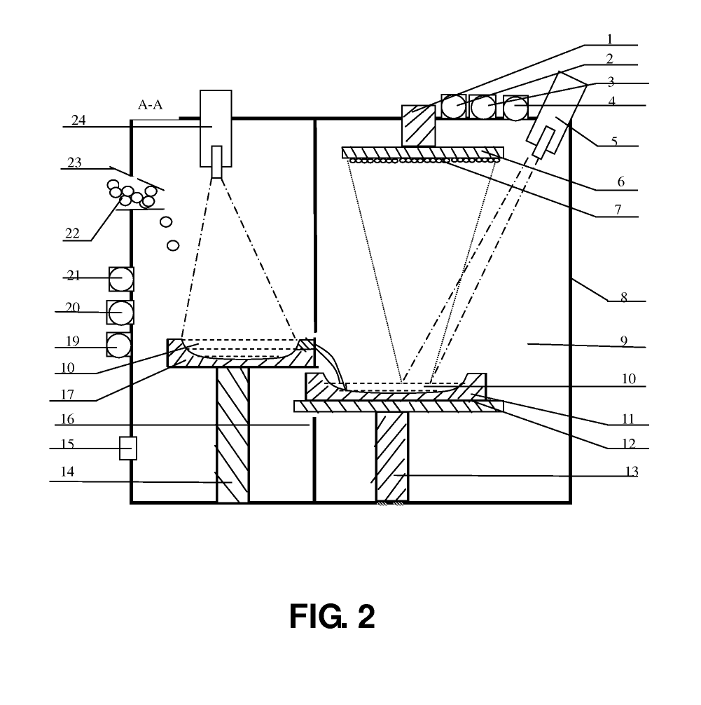

### EXAMPLES OF CONCRETE IMPLEMENTATION

The following illustrates the concrete implementation of this procedure with combination of technical solutions and detailed drawings.

According to Langmuir equation, ω_{B}=4.37×10⁻³×P_{B}\sqrt{M_{B}/T}γ_{B(l)inSi}⁰C where P_{B} is the saturated vapor pressure of B, γ_{B(l)inSi}⁰ is the activity coefficient for B in silicon. Since the very low saturated vapor pressure of B, the B contained in silicon is only one percent of silicon at a high melting temperature. Therefore B removal can be achieved by collecting evaporated silicon vapor.

Put the polysilicon material 22 of 0.0005% B, 0.0007% P into the water-cooled copper crucible 17. The polysilicon material 22 is hold in about the one third position of the water-cooled copper crucible 17. Close the vacuum cover 25; Vacuum process, start up the left rotary pump 19, the left roots pump 20, the right rotary pump 4, and the right roots pump 3 to get the vacuum chamber to low vacuum of 1 Pa, and then start up the left diffusion pump 21 and the right diffusion pump 2 to get the vacuum chamber to high vacuum of below 0.001 Pa; Pass the cooling water into water-cooled copper crucible 17 through the left water-cooled supporting bar 14 and pass the cooling water into water-cooled copper tray 12 through the right water-cooled supporting bar 13, maintaining the temperature of the water-cooled copper crucible and cooled copper tray below 50° C.; Preheat the left electron gun 24 with the high-voltage of 30 kV for 5 minutes. Then turn off the high-voltage and set the beam current of left electron gun 24 for 200 mA. After preheat for 5 minutes, turn off the beam current of left electron gun 24; Preheat the right electron gun 5 with the high-voltage of 30 kV for 5 minutes. Then turn off the high-voltage and set the beam current of right electron gun 5 for 200 mA. After preheat for 5 minutes, turn off the beam current of right electron gun 5. Turn on the high-voltage and the beam current of the left electron gun 24 simultaneously. After stability of the beam current, bombard the polysilicon material 22 in the water-cooled copper crucible 17 with the left electron gun 24. And then increase the beam current of the left electron gun 24 to 1000 mA and sustain bombardment, until the polysilicon 22 melts into low-P polysilicon 10; Put polysilicon 22 into the water-cooled copper crucible 17 constantly through the filler port 23, so that the low-P polysilicon 10 overflows into the graphite crucible 11; Turn on the high-voltage and the beam current of the right electron gun 5 simultaneously. After stability of the beam current, bombard the low-P polysilicon material 10 in the middle of the graphite crucible 11 with the right electron gun 5. And then increase the beam current of right electron gun 5 to 1000 mA and sustain bombardment; Rotate the supporting bar 1 of the deposition plate 6, take the speed of rotation of the deposition plate 6 to 5 rotations per minute, and collect the low-B silicon 7 evaporated to plate; Put polysilicon material 22 into the water-cooled copper crucible 17 constantly through the filler port 23, so as to ensure the sustainability of the reaction process; After the collecting process, turn off the left electron gun 24 and the right electron gun 5, and continue to pump the vacuum for 10 minutes; Turn off the left diffusion pump 21 and the right diffusion pump 2 in turn and continue to pump the vacuum for 5-10 minutes, then turn on the left roots pump 20 and the right roots pump 3, the left rotary pump 19 and the right rotary pump 4, open the valve 15 and vacuum cover 18 and take out silicon from the deposition plate 6; Through ELAN DRC-II-type inductively coupled plasma mass spectrometry equipment (ICP-MS) detection, B is decreased to lower than 0.00002% and P is reduced to below 0.00001%, which meets requirements of the solar grade silicon material.

The invention can be used to complete the simultaneous removal of impurities P and B in silicon with good removal effect and high removal efficiency, solving the problems of B removal with metallurgical technology, integrating a dual process for P and B removal from polysilicon, and laying basis for large-scale preparation of solar grade polysilicon materials.

What is claimed is:

1. A method for removal P and B from polysilicon by continuous melting is characterized in using two electron guns for transmitting electron beam to melt polysilicon, and P and B are removed simultaneously in a dual process. P was firstly removed, and then B in polysilicon with low content of P will be further removed through further melting for evaporation. The low-B and low-P polysilicon evaporated to the deposit board is collected. These steps as follows:
1) Take the polysilicon material (22) into the water-cooled copper crucible (17). The polysilicon material (22) is hold in about the one third position of the water-cooled copper crucible (17). Close the vacuum cover (18);
2) Vacuum process, start up the left rotary pump (19), the left roots pump (20), the right rotary pump (4), and the right roots pump (3) to get the vacuum chamber to low vacuum of 1 Pa, and then start up the left diffusion pump (21) and the right diffusion pump (2) to get the vacuum chamber to high vacuum of below 0.001 Pa;
3) Pass the cooling water into water-cooled copper crucible (17) through the left water-cooled supporting bar (14) and pass the cooling water into water-cooled copper tray (12) through the right water-cooled supporting bar (13), maintaining the temperature of the water-cooled copper crucible and cooled copper tray below 50° C.;
4) Preheat the left electron gun (24) with the high-voltage of 25-35 kV for 5-10 minutes. Then turn off the high-voltage and set the beam current of left electron gun (24) for 70-200 mA. After preheat for 5-10 minutes, turn off the beam current of left electron gun (24);
5) Preheat the right electron gun (5) with the high-voltage of 25-35 kV for 5-10 minutes. Then turn off the high-voltage and set the beam current of right electron gun 5 for 70-200 mA. After preheat for 5-10 minutes, turn off the beam current of right electron gun (5);
6) Turn on the high-voltage and the beam current of the left electron gun (24) simultaneously. After stability of the beam current, bombard the polysilicon material (22) in the water-cooled copper crucible (17) with the left electron gun (24). And then increase the beam current of the left electron gun (24) to 500-1000 mA and sustain bombardment, until the polysilicon (22) melts into low-P polysilicon (10);
7) Put polysilicon (22) into the water-cooled copper crucible (17) constantly through the filler port (23), so that the low-P polysilicon (10) overflows into the graphite crucible (11);
8) Turn on the high-voltage and the beam current of the right electron gun (5) simultaneously. After stability of the beam current, bombard the low-P polysilicon material (10) in the middle of the graphite crucible (11) with the right electron gun (5). And then increase the beam current of right electron gun 5 to 500-1000 mA and sustain bombardment;
9) Rotate the supporting bar (1) of the deposition plate (6), take the speed of rotation of the deposition plate (6) to 2-30 rotation s per minute, and collect the low-B silicon (7) evaporated to plate;
10) Put polysilicon material (22) into the water-cooled copper crucible (17) constantly through the filler port (23), so as to ensure the sustainability of the reaction process;
11) After the collecting process, turn off the left electron gun (24) and the right electron gun (5), and continue to pump the vacuum for 10-20 minutes;
12) Turn off the left diffusion pump (21) and the right diffusion pump (2) in turn and continue to pump the vacuum for 5-10 minutes, then turn on the left roots pump (20) and the right roots pump (3), the left rotary pump (19) and the right rotary pump (4), open the valve (15) and vacuum cover (18) and take out silicon from the deposition plate (6);

2. According to claim 1, the device used for continuous melting of polysilicon to remove P and B is characterized in that the vacuum cover (18) and vacuum circular cylinder (8) constitutes the shell of the device; the inner part of vacuum circular cylinder (8) is the vacuum chamber (9), which is formed by the left and right part and divided by the separation plate (16); the two parts are connected by a square port (25); Left water-cooled supporting bar (14) is fixed to the left bottom of the vacuum circular cylinder (8); Water-cooled copper crucible (17) is mounted on the left water-cooled supporting bar (14), and the right side of water-cooled copper crucible (17) is connected to the graphite crucible (11) in the right inner part through the square port (25); The left electron gun (24) is fixed on the left side of the vacuum circular cylinder (8), just over the water-cooled copper crucible (17); The right water-cooled supporting bar (13) is fixed on the right bottom of the vacuum circular cylinder (8), and the water-cooled copper tray (12) is installed on the right water-cooled supporting bar (13); The graphite crucible (11) is placed on the water-cooled copper tray (12), and the right electron gun (5) is fixed on the right side of the vacuum circular cylinder (8); The deposition plate (6) is connected to the supporting bar (1) and they are installed on the right inner top of the vacuum circular cylinder (8), just over the graphite crucible (11); The filler port (23), the left rotary pump (19), the left roots pump (20), the left diffusion pump (21) and the valve (15) are installed on the left side of the vacuum circular cylinder (8) respectively; The right rotary pump (4), the right roots pump (3) and the right diffusion pump (2) are installed in the upper right of the vacuum circular cylinder (8) respectively.

3. According to claim 2, the device used for continuous melting of polysilicon to remove P and B is characterized in that the deposition board (6) is made of silicon, ceramic or other material which has a low wetting with silicon.
